(19) United States
(12) Patent Application Publication
(10) Pub. No.: US 2009/0030798 A1
(43) Pub. Date: Jan. 29, 2009

(54) System and method for providing incentives to an end user for referring another end user

(75) Inventors: Jonathan Otto, Palm Beach, FL (US); Andrew Van Luchene, Santa Fe, NM (US); Raymond J. Mueller, Palm Beach Gardens, FL (US); Michael R. Mueller, San Francisco, CA (US)

Correspondence Address: SIMPSON & SIMPSON, PLLC, 5555 MAIN STREET, WILLIAMSVILLE, NY, 14221-5406, US

(73) Assignee: RetailDNA, LLC, West Palm Beach, FL (US)

(21) Appl. No.: 12/217,863

(22) Filed: Jul. 9, 2008

Related U.S. Application Data
(63) Continuation-in-part of application No. 12/151,038, filed on May 2, 2008.
Application No. 12/151,038 is a continuation-in-part of application No. 12/151,043, filed on May 2, 2008.
Application No. 12/151,043 is a continuation-in-part of application No. 11/983,679, filed on Nov. 9, 2007.
Application No. 11/983,679 is a continuation-in-part of application No. 09/993,228, filed on Nov. 14, 2001.

(51) Int. Cl. G06Q 30/00

(52) U.S. Cl. 705/14; 705/26

(57) ABSTRACT

A system for generating an incentive for an end user to refer other end users, including: first and second offer elements, in a processor for at least one specially programmed general-purpose computer. The first offer element: receives, using an interface element for the computer, a first order from an end user device, generates using the processor and a set of rules or an artificial intelligence program stored in a memory unit for the computer, a first offer in response to the first order, the offer conditional upon receipt of at least one email address; and transmits, using the interface element, the first offer. The second offer element receives, using the interface element, an address in response to the first offer; generates, using the processor, at least one second offer; and transmits, using the interface element, the at least one second offer to the at least one email address.

### CROSS-REFERENCE TO RELATED APPLICATIONS

This is a continuation-in-part patent application under 35 USC 120 of U.S. patent application Ser. No. 12/151,038, filed May 2, 2008 and entitled “Method and Apparatus for Generating and Transmitting an Order Initiation Offer to a Wireless Communications Device” and of U.S. patent application Ser. No. 12/151,043, filed May 2, 2008 and entitled “Method and System For Centralized Generation of a Business Executable Using Genetic Algorithms and Rules Distributed Among Multiple Hardware Devices,” which is a continuation-in-part of U.S. patent application Ser. No. 11/983,679, filed Nov. 9, 2007 and entitled “Method and System for Generating, Selecting, and Running Executables in a Business System Utilizing a Combination of User Defined Rules and Artificial Intelligence” which is a continuation-in-part patent application under 35 USC 120 of U.S. patent application Ser. No. 09/993,228, filed Nov. 14, 2001 and entitled “Method and apparatus for dynamic rule and/or offer generation,” which applications are incorporated herein by reference.

This application is related to: U.S. patent application Ser. No. 09/052,093 entitled “Vending Machine Evaluation Network” and filed Mar. 31, 1998; U.S. patent application Ser. No. 09/083,483 entitled “Method and Apparatus for Selling an Aging Food Product” and filed May 22, 1998; U.S. patent application Ser. No. 09/282,747 entitled “Method and Apparatus for Providing Cross-Benefits Based on a Customer Activity” and filed Mar. 31, 1999; U.S. patent application Ser. No. 08/943,483 entitled “System and Method for Facilitating Acceptance of Conditional Purchase Offers (CPOs)” and filed on Oct. 3, 1997, which is a continuation-in-part of U.S. patent application Ser. No. 08/923,683 entitled “Conditional Purchase Offer (CPO) Management System For Packages” and filed Sep. 4, 1997, which is a continuation-in-part of U.S. patent application Ser. No. 08/889,319 entitled “Conditional Purchase Offer Management System” and filed Jul. 8, 1997, which is a continuation-in-part of U.S. patent application Ser. No. 08/707,660 entitled “Method and Apparatus for a Cryptographically Assisted Commercial Network System Designed to Facilitate Buyer-Driven Conditional Purchase Offers,” filed on Sep. 4, 1996 and issued as U.S. Pat. No. 5,794,207 on Aug. 11, 1998; U.S. patent application Ser. No. 08/920,116 entitled “Method and System for Processing Supplementary Product Sales at a Point-Of-Sale Terminal” and filed Aug. 26, 1997, which is a continuation-in-part of U.S. patent application Ser. No. 08/822,709 entitled “System and Method for Performing Lottery Ticket Transactions Utilizing Point-Of-Sale Terminals” and filed Mar. 21, 1997; U.S. patent application Ser. No. 09/135,179 entitled “Method and Apparatus for Determining Whether a Verbal Message Was Spoken During a Transaction at a Point-Of-Sale Terminal” and filed Aug. 17, 1998; U.S. patent application Ser. No. 09/538,751 entitled “Dynamic Propagation of Promotional Information in a Network of Point-of-Sale Terminals” and filed Mar. 30, 2000; U.S. patent application Ser. No. 09/442,754 entitled “Method and System for Processing Supplementary Product Sales at a Point-of-Sale Terminal” and filed Nov. 12, 1999; U.S. patent application Ser. No. 09/045,386 entitled “Method and Apparatus For Controlling the Performance of a Supplementary Process at a Point-of-Sale Terminal” and filed Mar. 20, 1998; U.S. patent application Ser. No. 09/045,347 entitled “Method and Apparatus for Providing a Supplementary Product Sale at a Point-of-Sale Terminal” and filed Mar. 20, 1998; U.S. patent application Ser. No. 09/083,689 entitled “Method and System for Selling Supplementary Products at a Point-of Sale and filed May 21, 1998; U.S. patent application Ser. No. 09/045,518 entitled “Method and Apparatus for Processing a Supplementary Product Sale at a Point-of-Sale Terminal” and filed Mar. 20, 1998; U.S. patent application Ser. No. 09/076,409 entitled “Method and Apparatus for Generating a Coupon” and filed May 12, 1998; U.S. patent application Ser. No. 09/045,084 entitled “Method and Apparatus for Controlling Offers that are Provided at a Point-of-Sale Terminal” and filed Mar. 20, 1998; U.S. patent application Ser. No. 09/098,240 entitled “System and Method for Applying and Tracking a Conditional Value Coupon for a Retail Establishment” and filed Jun. 16, 1998; U.S. patent application Ser. No. 09/157,837 entitled “Method and Apparatus for Selling an Aging Food Product as a Substitute for an Ordered Product” and filed Sep. 21, 1998, which is a continuation of U.S. patent application Ser. No. 09/083,483 entitled “Method and Apparatus for Selling an Aging Food Product” and filed May 22, 1998; U.S. patent application Ser. No. 09/603,677 entitled “Method and Apparatus for selecting a Supplemental Product to offer for Sale During a Transaction” and filed Jun. 26, 2000; U.S. Pat. No. 6,119,100 entitled “Method and Apparatus for Managing the Sale of Aging Products and filed Oct. 6, 1997 and U.S. Provisional Patent Application Ser. No. 60/239,610 entitled “Methods and Apparatus for Performing Upsells” and filed Oct. 11, 2000.

By “related to” we mean that the present application and the applications noted above are in the same general technological area and have a common inventor or assignee. However, “related to” does not necessarily mean that the present application and any or all of the applications noted above are patentably indistinct, or that the filing date for the present application is within two months of any of the respective filing dates for the applications noted above.

### FIELD OF THE INVENTION

The invention relates generally to a method and system to generate and transmit incentives to an end user device, in response to an order received from the end user device, using one or both of at least one rule or an artificial intelligence program.

### BACKGROUND OF THE INVENTION

It would be advantageous for a retail entity receiving orders for goods or services to find ways of reaching other potential customers. Further, it would be advantageous for the retail entity to maximize incentives for obtaining ways of reaching potential customers and to maximize incentives for the potential customers while maximizing goals of the business.

Thus, there is a long-felt need to provide a system and a method to intelligently and automatically facilitate contact with potential customers for a business location and maximize incentives for the potential customers while maintaining alignment with criteria for the business location.

### SUMMARY OF THE INVENTION

The invention broadly comprises a system for generating an incentive for an end user to refer other end users, including: a first offer element, in a processor for at least one specially programmed general-purpose computer, arranged to receive, using an interface element for the at least one specially programmed general-purpose computer, a first order from an end user device, the first order for an item or service available from a first business entity; generate, using the processor and at least one of a first set of rules or a first artificial intelligence program stored in a memory unit for the at least one specially programmed general-purpose computer, a first offer in response to the first order, redemption of the first offer contingent upon receipt, in the at least one specially programmed general-purpose computer, of an email address; and transmit, using the interface element, the first offer. The system also includes a second offer element, in the processor, arranged to receive, using the interface element, at least one email address in response to the first offer; generate, using the processor, at least one second offer; and transmit, using the interface element, the at least one second offer to the at least one email address.

In a first embodiment, the second offer element is arranged to determine if the at least one email address is valid and to transmit the at least one second offer only to a valid at least one email address. In a second embodiment, the second offer element is arranged to generate the at least one second offer using at least one of a second set of rules or a second artificial intelligence program stored in the memory unit. In one embodiment, the first and second sets of rules are the same or the first and second artificial intelligence programs are the same. In a third embodiment, the end user device is a wireless communications device (WCD) with a memory element and a processor and the WCD is arranged to store at least one second rule in the memory element for the WCD and to execute, using the processor in the WCD, the first offer according to the at least one second rule.

In a fourth embodiment, the first offer element is arranged to receive, using the interface element, at least one second rule from a WCD, or from a general-purpose computer associated with a second business entity; to store the at least one second rule in the memory element; to modify the first offer using the at least one second rule; and to transmit, using the interface element, the modified first offer to the end user device. In one embodiment, the end user device and the WCD are the same or the first and second business entities are the same.

In a fifth embodiment, the second offer element is arranged to receive, using the interface element, a second order in response to the second offer and to generate a redemption authorization for the first offer in response to receiving the second order. In a sixth embodiment, the first offer element is arranged to transmit the first offer to the end user device or the second offer element is arranged to receive the at least one email address from the end user device.

The invention also broadly comprises a system for generating an incentive for an end user to refer other end users, including: a first offer element, in a processor for at least one specially programmed general-purpose computer, arranged to receive, using an interface element for the at least one specially programmed general-purpose computer, a first order from an end user device, the first order for an item or service available from a first business entity; to generate, using the processor, a first offer in response to the first order, redemption of the first offer contingent upon receipt, in the at least one specially programmed general-purpose computer, of an email address; and to transmit, using the interface element, the first offer. The system also includes a second offer element, in the processor, arranged to receive, using the interface element, at least one email address in response to the first offer; to generate, using the processor and at least one of a first set of rules or a first artificial intelligence program stored in a memory unit for the at least one specially programmed general-purpose computer, at least one second offer; and to transmit, using the interface element, the at least one second offer to the at least one email address.

In one embodiment, the first offer element is arranged to generate the at least one first offer using at least one of a second set of rules or a second artificial intelligence program stored in the memory unit.

The invention further broadly comprises a method for generating an incentive for an end user to refer other end users.

It is a general object of the present invention to provide a system and a method to intelligently and automatically facilitate contact with potential customers for a business location and maximize incentives for the potential customers while maintaining alignment with criteria for the business location.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic block diagram of a present invention apparatus for generating and transmitting an order initiation offer to a wireless communications device (WCD);

FIG. 2 is a flow chart of a present invention method for generating and transmitting an order initiation offer to a wireless communications device (WCD);

FIG. 3 is a schematic block diagram of a present invention system for generating an incentive for an end user to refer other end users;

FIG. 4 is a flow chart of a present invention method for generating an incentive for an end user to refer other end users; and,

FIG. 5 is a flow chart of a present invention method for generating an incentive for an end user to refer other end users.

### DETAILED DESCRIPTION OF THE PREFERRED EMBODIMENT

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein shall include the same meaning as commonly understood to one of ordinary skill in the art to which this invention belongs. Although any methods, devices or materials similar or equivalent to those described herein can be used in the practice or testing of the invention, the preferred methods, devices, and materials are now described.

It should be understood that the use of “or” in the present application is with respect to a “non-exclusive” arrangement, unless stated otherwise. For example, when saying that “item x is A or B,” it is understood that this can mean one of the following: 1) item x is only one or the other of A and B; and 2) item x is both A and B. Alternately stated, the word “or” is not used to define an “exclusive or” arrangement. For example, an “exclusive or” arrangement for the statement “item x is A or B” would require that x can be only one of A and B.

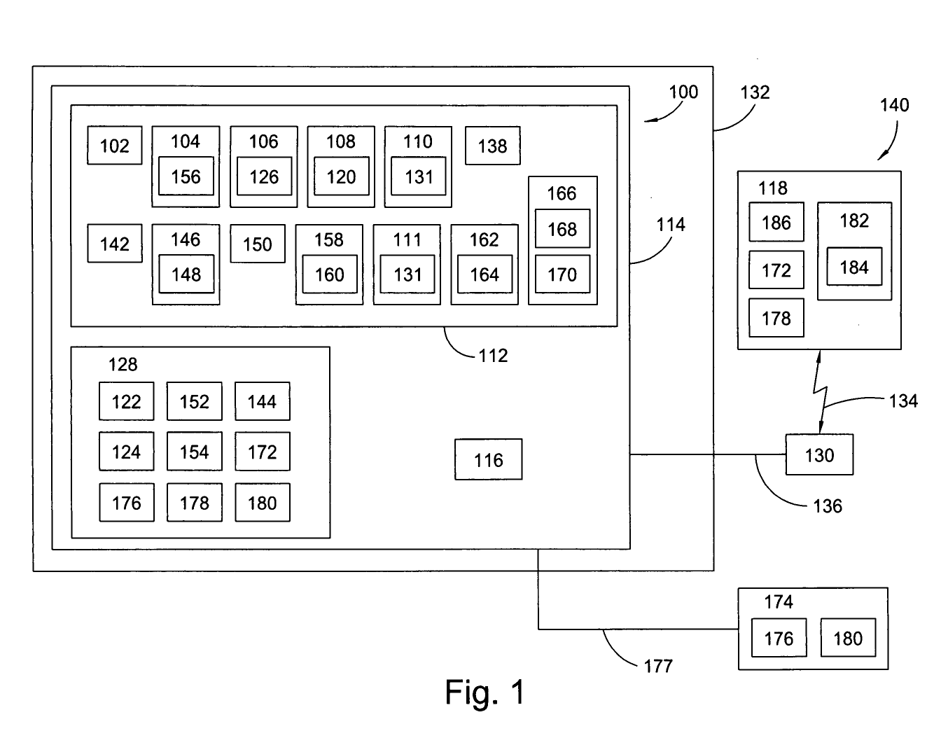

FIG. 1 is a block diagram for present invention system 100 for generating and transmitting an order initiation offer to a wireless communications device (WCD). System 100 includes: identification element 102, eligibility element 104, executable element 106, offer element 108, transceiver element 110, and order initiation element 111, all located in processor 112 of at least one specially programmed general-purpose computer 114. Alternately stated, elements 102, 104, 106, 108, 110, and 111, and any other elements described as being in the processor are functions of the processor or are functions carried out by the processor.

Element 102 identifies, using interface element 116, WCD 118. The eligibility element determines if the WCD is eligible to receive order initiation offer 120. Offer 120 is an offer that is made that when accepted (further described below) initiates a transaction. The executable element is arranged to generate, using one or both of rules 122 and artificial intelligence program 124, at least one executable 126. The set of rules and the artificial intelligence program are stored in memory unit 128. In one embodiment, the executable is generated as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In one embodiment, computer 114 receives at least one modifying rule 172 from a WCD and stores the rule in memory 128. In another embodiment, the WCD is WCD 118. The executable element modifies executable 126 using rule 172. The WCD generates rule 172, and the executable element modifies executable 126 as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment, computer 174, separate from computer 114, transmits modifying rule 176 to computer 114. Computer 174 can be in location 132 (not shown) or can be in a different location. Computer 174 can be associated with a business entity associated with location 132 or can be associated with a different business entity. Connection 177 between computers 114 and 342 is any type known in the art. In another embodiment (not shown), multiple computers 174 are included and respective computers among the multiple computers can be associated with the same or different business entities. Computer 114 stores modifying rule 176 in memory 128. Element 106 modifies executable 126 using rule 176. Computer 174 generates rule 176, and element 106 modifies executable 126, respectively, as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

The executable is directed toward determining an offer that is most acceptable to an end user of the WCD and best meets prescribed criteria of the entity making the offer. For example, acceptability could be based on price, free items, or other criteria mentioned below. Rules 122 or program 124 are used to find the appropriate combination of acceptability and entity criteria.

The offer element generates, for an eligible WCD and using the at least one executable, an appropriate order initiation offer 120. In general, the core of offer 120 is shaped by, determined by, or consists of executable 126. The transceiver element transmits, using the interface element, the appropriate order initiation offer 120 to wireless communications network 130 for transmission to the WCD. The transceiver element also is arranged to receive, via the interface element, response 131, including an order, from the WCD. Element 111 initiates fulfillment of the order by any means known in the art.

By interface element, we mean any combination of hardware, firmware, or software in a computer used to enable communication or data transfer between the computer and a device, system, or network external to the computer. The interface element can connect with the device, system, or network external to the computer, for example, network 130, using any means known in the art, including, but not limited to a hardwire connection, an optical connection, an Internet connection, or a radio frequency connection. Processor 112 and interface element 116 can be any processor or interface element, respectively, or combination thereof, known in the art.

Computer 114 can be any computer or plurality of computers known in the art. In one embodiment, the computer is located in a retail location with which system 100 is associated, for example, location 132. In another embodiment (not shown), all or parts of the computer are remote from retail locations with which system 100 is associated. In a further embodiment, computer 114 is associated with a plurality of retail locations with which system 100 is associated. Thus, the computer provides the functionality described for more than one retail location. In one embodiment, offer 120 is for an item, good, or service provided by the entity associate with location 132.

A WCD is defined supra. WCD 118 can be any WCD known in the art. In one embodiment, WCD 118 is owned by, leased by, or otherwise already in possession of the end user when system 100 interfaces with the WCD. In the description that follows, it is assumed that the WCD is owned by, leased by, or otherwise already in possession of the end user when system 100 interfaces with the WCD. In general, the WCD communicates with a network, for example, network 130, via radio-frequency connection 134. Network 130 can be any network known in the art. In one embodiment, the network is located outside of the retail location, for example, the network is a commercial cellular telephone network. In one embodiment. (not shown), the network is located in a retail location, for example, the network is a local network, such as a Bluetooth network. The interface element can connect with network 130 using any means known in the art, including, but not limited to a hardwire connection, an optical connection, an Internet connection, or a radio frequency connection. In the figures, a non-limiting example of a hardwire connection 136 is shown. In one embodiment, device 118 is connectable to a docking station (not shown) to further enable communication between device 118 and system 100. Any docking station or docking means known in the art can be used. That is, when the device is connected to the docking station, a link is established between the device and system 100.

In a first embodiment, system 100 includes location element 138 in the processor, which determines, using the interface element, location 140 for the WCD. The location of the WCD can be determined using any means known in the art, including, but not limited to, GPS technology and information from network 130. Then, the eligibility element determines eligibility in response to location 140, the executable element generates the at least one executable responsive to location 140, or the offer element generates an appropriate order initiation offer responsive to location 140. It should be understood that any combination of the eligibility, executable, and offer elements can operate responsive to location 140. Any criteria known in the art can be used to control the operation of the eligibility, executable, and offer elements responsive to location 140. For example, the elements can operate when the WCD is within a certain specified distance from one or more retail locations, for example, location 132; the elements can operate to generate offer 120 for a specific retail location according to location 140; or the elements can operate to generate offer 120 offering options with respect to a plurality of retail locations (not shown) based on respective distances of the WCD from the plurality of locations.

In a second embodiment, system 100 includes transaction element 142 that accesses transaction history 144, stored in the memory unit, for the WCD or an end user (not shown) associated with the WCD. In one embodiment, the history is stored in a separate computer system (not shown) accessed by system 100. The eligibility element determines eligibility in response to history 144, the executable element generates the at least one executable responsive to history 144, or the offer element generates an appropriate order initiation offer responsive to history 144. It should be understood that any combination of the eligibility, executable, and offer elements can operate responsive to history 144.

Any criteria known in the art can be used to control the operation of the eligibility, executable, and offer elements responsive to history 144. For example, executable 126 can be generated in response to trends noted in the history. The executable can be directed to a continuation of the trend or can derive variants from the trend that may be acceptable to the end user and in the interest of the retail location. Further, the continuation or variants can be aligned with parameters defined for the retail location. For example, the executable can be addressed to a desired promotion, conditions at the retail location, such as stock on hand, or attempts to increase a total bill for the end user.

In another embodiment, history 144 includes searches made using the WCD or communications by the WCD. Alternately stated, system 100 is linked to search browsers associated with the WCD. Any type of search or WCD communication known in the art can be included in history 144. For example, if the WCD has been used to search for products typically available at a retail location similar to location 132, the offer element generates offers for transmission to the WCD when the WCD is within a specified location of such a retail location, for example, location 132. As another example, the communications can be, but are not limited to, telephone calls or email messages to a specific retail location or to a category of retail locations. As another example, if history 144 shows that the WCD has communicated with location 132, then eligibility or the offer can be tailored in response to this information.

In a third embodiment, the eligibility element determines eligibility in response to a time of day, in general, the time of day when the WCD is identified, the executable element generates the at least one executable responsive to the time of day, or the offer element generates an appropriate order initiation offer responsive to the time of day. It should be understood that any combination of the eligibility, executable, and offer elements can operate responsive to the time of day. Any criteria known in the art can be used to control the operation of the eligibility, executable, and offer elements responsive to the time of day. For example, executable 126 can be generated in response to trends for an end user with respect to the time of day or with parameters for the retail location associated with the time of day. The executable can be directed to a continuation of the trend or can derive variants from the trend that may be acceptable to the end user. Further, the continuation or variants can be aligned with parameters defined for the retail location. For example, the executable can be addressed to a desired promotion, conditions at the retail location, such as stock on hand, or attempts to increase a total bill for the end user.

In a fourth embodiment, the eligibility element determines eligibility in response to the day of the week, the executable element generates the at least one executable responsive to the day of the week, or wherein the offer element generates an appropriate order initiation offer responsive to the day of the week. It should be understood that any combination of the eligibility, executable, and offer elements can operate responsive to the day of the week. Any criteria known in the art can be used to control the operation of the eligibility, executable, and offer elements responsive to the day of the week. For example, executable 126 can be generated in response to trends for an end user with respect to the day of the week or with parameters for the retail location associated with the day. In general, this embodiment operates similar to the embodiment directed to the time of day.

In a fifth embodiment, system 100 includes volume element 146, in the processor, which determines transaction volume 148 for at least one retail location, for example, location 132. Element 146 can use any means known in the art to determine volume 148. In one embodiment, element 146 interfaces with another computer system (not shown) associated with location 132 to determine or obtain volume 148. The eligibility element determines eligibility in response to volume 148, the executable element generates the at least one executable responsive to volume 148, or the offer element generates an appropriate order initiation offer responsive to volume 148. It should be understood that any combination of the eligibility, executable, and offer elements can operate responsive to volume 148. Any criteria known in the art can be used to control the operation of the eligibility, executable, and offer elements responsive to volume 148. For example, executable 126 can be generated to create offers that are higher profit (may be less acceptable to an end user) if the volume is high or can generate lower profit (more acceptable offers) if the volume is low. Also, executable 126 can be refined to address respective volume data for various products or groups of products, rather than overall volume.

In a sixth embodiment, system 100 includes order element 150, in the processor, which determine whether an order (not shown) has been placed previously using the WCD. In one embodiment, element 150 interfaces with another computer system (not shown) associated with location 132 to determine or obtain information regarding a previous order. Then, the eligibility element determines eligibility in response to whether an order has been placed previously using the WCD, the executable element generates the at least one executable responsive to whether an order has been placed previously using the WCD, or the offer element generates an appropriate order initiation offer responsive to whether an order has been placed previously using the WCD. It should be understood that any combination of the eligibility, executable, and offer elements can operate responsive to whether an order has been placed previously using the WCD. Any criteria known in the art can be used to control the operation of the eligibility, executable, and offer elements responsive to whether an order has been placed previously using the WCD. For example, executable 126 can be generated to present more acceptable (perhaps lower profit) offers to first time orders from the WCD or can present more acceptable offers to reward continued use of the WCD to place orders.

In a seventh embodiment, element 150 determines whether an order has been placed previously using the WCD during a specified time of day or a specified day of the week. Then, the eligibility element determines eligibility in response to whether an order has been placed previously using the WCD during a specified time of day or a specified day of the week, the executable element generates the at least one executable responsive to whether an order has been placed previously using the WCD during a specified time of day or a specified day of the week, or the offer element generates an appropriate order initiation offer responsive to whether an order has been placed previously using the WCD during a specified time of day or a specified day of the week. It should be understood that any combination of the eligibility, executable, and offer elements can operate responsive to whether an order has been placed previously using the WCD during a specified time of day or a specified day of the week. Any criteria known in the art can be used to control the operation of the eligibility, executable, and offer elements responsive to whether an order has been placed previously using the WCD during a specified time of day or a specified day of the week. This embodiment is a refinement of the previous embodiment. For example, additional temporal criteria are added to the generation of the executable.

In an eighth embodiment, the eligibility element generates, using at least one of set of rules 152 and artificial intelligence program 154, at least one executable 156. Set of rules 152 and artificial intelligence program 154 are stored in the memory unit. The eligibility element is arranged to determine if the WCD is eligible to receive an order initiation using executable 156. In one embodiment, executable 156 is generated as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In one embodiment, computer 114 receives at least one modifying rule 178 from a WCD and stores the rule in memory 128. In another embodiment, the WCD is WCD 118. Element 104 modifies executable 156 using rule 178. The WCD generates rule 178 and element 104 modifies executable 156 as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment, computer 174 transmits at least one modifying rule 180 to computer 114. Computer 114 stores modifying rule 180 in memory 128. Element 104 modifies executable 156, using rule 180. Computer 174 generates rule 180, and element 104 modifies executable 156, respectively, as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment, the eligibility element determines if an end user associated with the WCD is eligible for the order initiation offer. That is, the criteria with respect to eligibility are with respect to an end user of the WCD. In another embodiment, system 100 includes receiving element 158, in the processor, arranged to receive, using the interface element, transmission 160 from the WCD via the communication network. The identification element identifies the WCD in response to the transmission, using any means known in the art. That is, rather than system 100 contacting the WCD to initiate the operations noted above, system 100 initiates the operations after being contacted by the WCD.

In a further embodiment, system 100 includes inventory element 162, in the processor, which obtains inventory information 164. In general, information 164 related to inventory availability, for example, an inventory of product or services in stock or ready for purchase at the retail location. For example, in a restaurant, information 164 might be regarding the number and type of already-prepared breakfast items at the restaurant. In a location selling durable goods, such as appliances, the information could be regarding whether various of the durable goods are in stock at the retail location. In yet another embodiment, element 162 interfaces with another system, for example, a local or centralized computer system associated with operations at the retail location, to obtain information 164, or to obtain data to determine information 164. In a still further embodiment, element 162 compiles the data necessary to determine information 164. For example, operations at the retail location are processed by computer 114. The eligibility element determines eligibility in response to inventory information, for example, if there is a surplus of items on hand, the requirements for eligibility can be loosened, the executable element generates the at least one executable responsive to inventory information, or the offer element generates an appropriate order initiation offer responsive to inventory information, for example, if the supply of items on hand is low, offers for that item can be made more profitable for the retail location.

In one embodiment, system 100 includes registration element 166, in the processor, which communicates with the WCD through the transceiver element. Element 166 transmits information 168 regarding registration of a WCD with system 100, for example, soliciting registration, providing instructions for registering, and promoting registration. Element 166 also receives registration information 170 for the WCD.

In one embodiment, memory element 182 in WCD 118 stores at least one rule 184. Processor 186 in the WCD implements offer 120 according to rule 184. The WCD generates rule 184, and operates on offer 120 as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment the offer element determines redemption rate 185 for offer 126. The executable element generates at least one executable 186, using the redemption rate, and at least one of set of rules 187 or artificial intelligence program 188 stored in memory unit 128. The offer element generates appropriate order initiation offer 189 using executable 186, and the transmission element transmits, using the interface element, offer 189 to the wireless communications network for transmission to the WCD.

In another embodiment, the offer element modifies, using the redemption rate, rules 122 or artificial intelligence program 124 to create rules 187 or artificial intelligence program 188, respectively.

In a further embodiment, offers 120 and 189 are transmitted to the WCD regardless of the location of the WCD with respect to a business location, for example, location 132, and stored in memory 182. The location element determines, using the interface element, when the WCD is within a specified distance (not shown) of the business location and retrieves, using the interface element, offer 120 or 189 from memory 182 for presentation, for example, on a point of sale station for the business location. In another embodiment, offers 120 and 189 are stored in memory 128 until the location element, using the interface element, identifies the WCD as being within a specified distance (not shown) of the business location, at which time offers 120 and 189 are transmitted to the WCD.

In one embodiment, computer 114 receives at least one modifying rule 190 from a WCD and stores the rule in memory 128. In another embodiment, the WCD is WCD 118. Element 106 modifies executable 186 using rule 190. The WCD generates rule 190 and element 106 modifies executable 186 as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment, computer 174 transmits at least one modifying rule 191 to computer 114. Computer 114 stores modifying rule 191 in memory 128. Element 106 modifies executable 186, using rule 191. Computer 174 generates rule 191, and element 106 modifies executable 186, respectively, as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

It should be understood that various storage and removal operations, not explicitly described above, involving memory 128 and as known in the art, are possible with respect to the operation of system 100. For example, outputs from and inputs to the general-purpose computer can be stored and retrieved from the memory elements and data generated by the processor can be stored in and retrieved from the memory.

It should be understood that the locating element can determine the distance of the WCD from more than one business, or retail, location. It also should be understood that the offer element can generate and transmit more than one offer for a business location and can generate respective offers for more than one business location or entity. It also should be understood that a plurality of distance and offer criteria and metrics can be used by the location and offer elements to determine a distance to use and to generate an offer, respectively. The criteria and metrics can include, but are not limited to, information specific to operations at a particular business entity or business location, geographical information, and temporal aspects, such as time of day.

It should be understood that system 100 can be operated by the same business entity operating or owning a business location using the system, or can be operated by a third party different than the business entity operating or owning the business location using the system. In one embodiment, a third party operates system 100 as disclosed by commonly-owned U.S. patent application Ser. No. 11/985,141: “UPSELL SYSTEM EMBEDDED IN A SYSTEM AND CONTROLLED BY A THIRD PARTY,” inventors Otto et al., filed Nov. 13, 2007.

It should be understood that system 100 can be integral with a computer operating system for a business location, for example, location 132 or with a business entity operating the business location. It also should be understood that system 100 can be wholly or partly separate from the computer operating system for a retail location, for example, location 132, or with a business entity operating the business location.

It should be understood that although individual rule sets and artificial intelligence programs are discussed, the individual rule sets and AI programs can be combined into composite rules sets or artificial intelligence programs. Any combination of individual rule sets or artificial intelligence programs is included in the spirit and scope of the claimed invention. For example, rules 122 and 152 can be a single set of rules (not shown) or artificial intelligence programs 124 and 154 can be a single program (not shown).

It should be understood that the examples above regarding executables are non-limiting, are meant to provide only a broad overview, and do not address the number, complexity, structure, or interrelationships of the operations included in the actual generation of the executables.

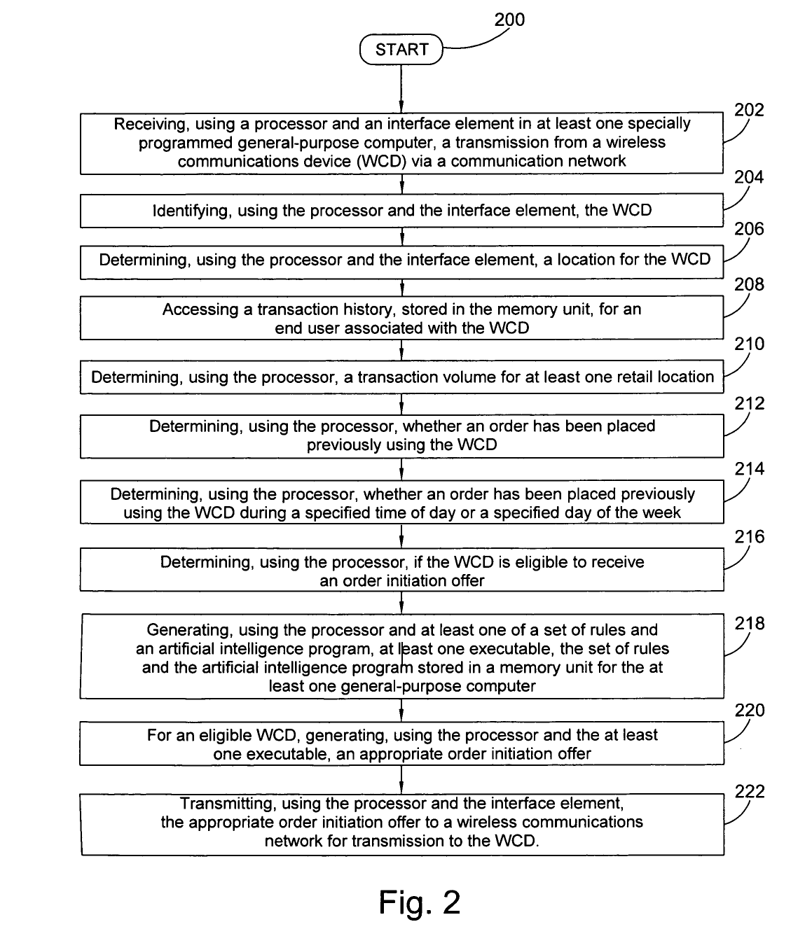

FIG. 2 is a flow chart illustrating a present invention computer-based method for generating and transmitting an order initiation offer to a wireless communications device (WCD). Although the method in FIG. 2 is depicted as a sequence of numbered steps for clarity, no order should be inferred from the numbering unless explicitly stated. The method starts at Step 200. Step 204 identifies, using a processor and an interface element in at least one specially programmed general-purpose computer, a WCD. Step 216 determines, using the processor, if the WCD is eligible to receive an order initiation offer. Step 218 generates, using the processor and at least one of a set of rules or an artificial intelligence program, at least one executable, the set of rules and the artificial intelligence program stored in a memory unit for the at least one general-purpose computer. Step 220, for an eligible WCD, generates, using the processor and the at least one executable, an appropriate order initiation offer. Step 222 transmits, using the processor and the interface element, the appropriate order initiation offer to a wireless communications network for transmission to the eligible WCD.

In a first embodiment, step 206 determines, using the processor and the interface element, a location for the WCD and determining if the WCD is eligible to receive an order initiation offer includes determining in response to the location, generating at least one executable includes generating the at least one executable responsive to the location, or generating an appropriate order initiation offer includes generating the appropriate order initiation offer responsive to the location.

In a second embodiment, step 208 accesses a transaction history, stored in the memory unit, for an end user associated with the WCD and determining if the WCD is eligible to receive an order initiation offer includes determining in response to the transaction history, and generating at least one executable includes generating the at least one executable responsive to the transaction history, or generating an appropriate order initiation offer includes generating the appropriate order initiation offer responsive to the transaction history. In one embodiment, the history includes searches made using the WCD or communications by the WCD. Alternately stated, the method links to search browsers associated with the WCD. Any type of search or WCD communication known in the art can be included in the history. For example, if the WCD has been used to search for products typically available at a retail location similar to the retail location, step 220 generates offers for transmission to the WCD when the WCD is within a specified location of such a retail location. As another example, the communications can be, but are not limited to, telephone calls or email messages to a specific retail location or to a category of retail locations. As another example, if the history shows that the WCD has communicated with the retail location, then steps 216 or 220 can be tailored in response to this information.

In a third embodiment, step 210 determines, using the processor, a transaction volume for at least one retail location and determining if the WCD is eligible to receive an order initiation offer includes determining in response to the transaction volume, and generating at least one executable includes generating the at least one executable responsive to the transaction volume, or generating an appropriate order initiation offer includes generating the appropriate order initiation offer responsive to the transaction volume.

In a fourth embodiment, step 212 determines, using the processor, whether an order has been placed previously using the WCD and determining if the WCD is eligible to receive an order initiation offer includes determining in response to whether an order has been placed previously using the WCD, and generating at least one executable includes generating the at least one executable responsive to whether an order has been placed previously using the WCD, or generating an appropriate order initiation offer includes generating the appropriate order initiation offer responsive to whether an order has been placed previously using the WCD.

In a fifth embodiment, step 214 determines, using the processor, whether an order has been placed previously using the WCD during a specified time of day or a specified day of the week and determining if the WCD is eligible to receive an order initiation offer includes determining in response to whether an order has been placed previously using the WCD during the specified time of day or the specified day of the week, and generating at least one executable includes generating the at least one executable responsive to whether an order has been placed previously using the WCD during the specified time of day or the specified day of the week, or generating an appropriate order initiation offer includes generating the appropriate order initiation offer responsive to whether an order has been placed previously using the WCD during the specified time of day or the specified day of the week.

In a sixth embodiment, step 216 obtains, using the processor, inventory information and determining if the WCD is eligible to receive an order initiation offer includes determining in response to the inventory information, and generating at least one executable includes generating the at least one executable responsive to the inventory information, or generating an appropriate order initiation offer includes generating the appropriate order initiation offer responsive to the inventory information.

In a seventh embodiment, step 224 determines, using the processor, a redemption rate for the first appropriate order initiation offer; step 226 generates, using the processor, the redemption rate, and at least one of a second set of rules and a second artificial intelligence program stored in the memory unit, at least one second executable; step 228 generates, using the processor and the at least one second executable, a second appropriate order initiation offer; and step 230 transmits, using the processor and the interface element, the second appropriate order initiation offer to the wireless communications network for transmission to the eligible WCD. In an eighth embodiment, step 232 modifies, using the processor and the redemption rate, the at least one of a first set of rules and a first artificial intelligence program to create the at least one of a second set of rules and a second artificial intelligence program.

In a ninth embodiment, determining, using the processor, if the WCD is eligible to receive an order initiation offer includes using at least one of the set of rules or the artificial intelligence program. In a tenth embodiment, determining if the WCD is eligible to receive an order initiation offer includes determining if an end user associated with the WCD is eligible for the order initiation offer. In an eleventh embodiment, determining if the WCD is eligible to receive an order initiation offer includes determining eligibility in response to the time of day, generating at least one executable includes generating the at least one executable responsive to the time of day, or generating an appropriate order initiation offer includes generating the appropriate order initiation offer responsive to the time of day. In a twelfth embodiment, determining if the WCD is eligible to receive an order initiation offer includes determining in response to a day of the week, generating at least one executable includes generating the at least one executable responsive to the day of the week, or generating an appropriate order initiation offer includes generating the appropriate order initiation offer responsive to the day of the week.

In a thirteenth embodiment, step 202 receives, using the processor and the interface element, a transmission from the WCD via the communication network and identifying a WCD includes identifying the WCD in response to the transmission.

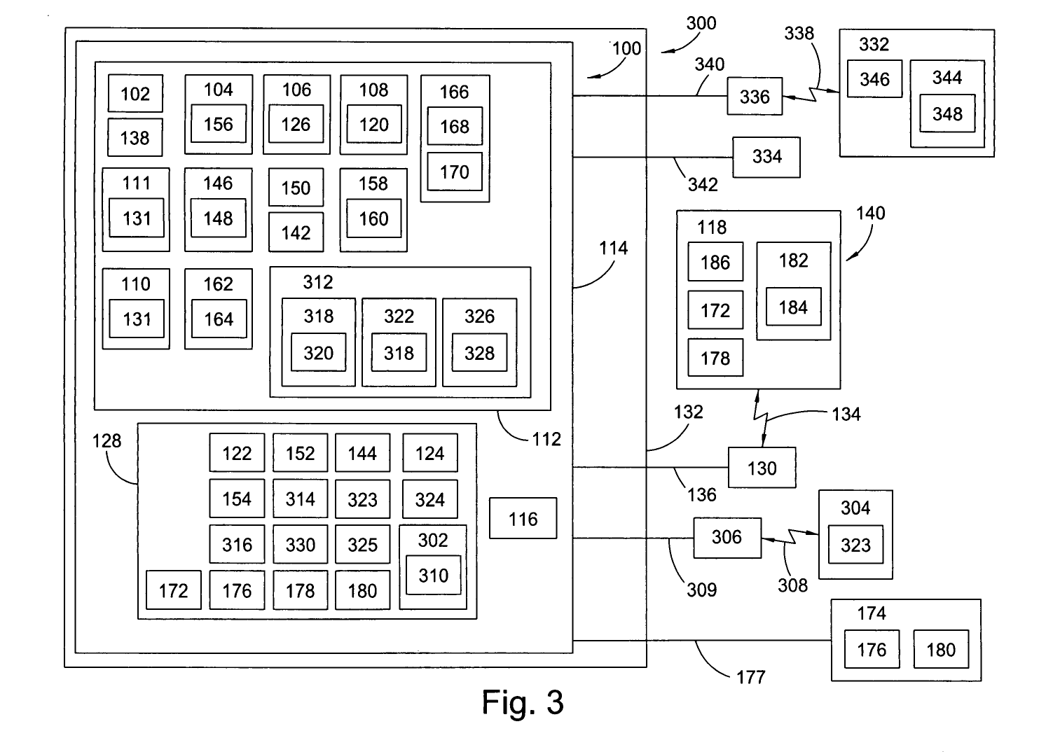

FIG. 3 is a block diagram for present invention system 300 for generating an incentive for an end user to refer other end users. The following should be viewed in light of FIGS. 1 through 3. System 300 is at least partially based on system 100 described in FIG. 1. Offer element 302, in processor 112 receives, using interface element 116, order 304 from an end user device (hereafter referred to as the EUD) and stores the order in memory 128. In one embodiment, order 304 is the same as order 131. In another embodiment, order 302 includes at least one item or service 306 available from a retail business entity associated with location 132 (hereafter referred to as the first business entity). Offer element 304 generates, using at least one of at least one rule 308 or AI program 310, stored in memory 128, referral offer 312 in response to the order and transmits, using the interface element, offer 312. In general, the use of an Al program in system 300 includes the generation of one or more executables that are used to generate or modify an offer or constitute the offer. In general, the referral offer presents an incentive to the recipient of offer 312 to provide one or more email addresses, presumably of persons that may be potential customers for the business entity. Any type of incentive known in the art can be included in offer 312, including, but not limited to, a discounted price for an item or service, a free item or service, or a desirable augmentation in a loyalty program associated with the EUD or an end user of the EUD.

System 300 also includes offer element 314, in processor 112, which is arranged to receive, using the interface element, at least one address, for example email address, 316 in response to the transmittal of offer 312. Offer element 314 stores address 316 in the memory element, generates at least one offer 318, and transmits, using the interface element, offer 318 to the at least one email address. In one embodiment, element 314 determines if address 316 is valid and transmits offer 318 only to a valid email address. Any criteria known in the art can be used to determine validity. In another embodiment, offer element 314 generates offer 318 using at least one of a set of rules 320 or AI program 322 stored in the memory unit. In a further embodiment, rules 308 and 320 are the same and/or programs 310 and 322 are the same.

In general, the discussion, in the description of FIG. 1, for offer element 108 and the use of rules and AI programs to generate an offer is applicable to elements 302 and 314 and offers 312 and 318, respectively.

The EUD can be any EUD known in the art. In one embodiment, the EUD is WCD 118. In another embodiment (not shown), the EUD is one of a self-serve kiosk, a point of sale terminal, or a card authorization terminal.

In one embodiment, the EUD is WCD 324 and memory element 326 in WCD 324 stores at least one rule 328 and processor 330 in WCD 324 executes, or implements, offer 312 according to rule 328. WCD 324 is connected to wireless communications network 332 with radio frequency connection 334. Network 332 is connected to computer 114 with hardwire connection 336. The discussion, in the description of FIG. 1, of WCD 118 and network 130 is applicable to WCD 324 and network 332, respectively. The discussion, in the description of FIG. 1, of WCD 118 and rule 184 is applicable to WCD 324 and rule 328, respectively. In another embodiment, WCDs 118 and 324 are the same.

In a first embodiment, element 302 receives, using the interface element, at least one rule 338 from WCD 340 or receives rule 338 from general-purpose computer 342 associated with a second business entity. Element 302 stores rule 338 in memory element 128. The business entity associated with computer 342 can be related to or can be the same as the business entity for location 132 or can be a separate business entity. In a second embodiment (not shown), multiple computers 342 are included and respective computers among the multiple computers can be associated with the same or different business entities. Offer element 302 modifies offer 312 using rule 338 and transmits, using the interface element, modified offer 312 to the EUD. In a further embodiment, the EUD is WCD 118, WCD 324, or WCD 340. In a third embodiment, two or more of WCDs 118, 324, or 340 are the same. WCD 340 is connected to wireless communications network 344 with radio frequency connection 346. Network 344 is connected to computer 114 with hardwire connection 348. Connection 350 between computers 114 and 342 is any type known in the art. The discussion, in the description of FIG. 1, of WCD 118 and network 130 is applicable to WCD 340 and network 344, respectively. The discussion, in the description of FIG. 1, of WCD 118 and rules 172 and 178 and computer 174 and rules 176 and 180 is applicable to the WCD, for example, WCD 340, and rule 338 and to the computer, for example, computer 342, and rule 338, respectively. In yet another embodiment (not shown), computers 174 and 342 are the same. In a still further embodiment, the first and second business entities are the same.

In one embodiment, element 314 receives, using the interface element, at least one rule 352 from a WCD or from a general-purpose computer associated with a third business entity and stores rule 352 in memory element 128. Offer element 314 modifies offer 318 using rule 352 and transmits, using the interface element, modified offer 318 to addresses 316. In another embodiment, the WCD is WCD 118, WCD 324, or WCD 340. In a further embodiment, two or more of WCDs 118, 324, or 340 are the same. In yet another embodiment, the general-purpose computer is computer 342 or computer 174. The discussion, in the description of FIG. 1, of WCD 118 and rules 172 and 178 and computer 174 and rules 176 and 180 is applicable to the WCD, for example, WCD 340, and rule 352 and to the computer, for example, computer 342, and rule 352, respectively. In a still further embodiment, at least two of the first, second or third business entities are the same.

In one embodiment, element 314 receives, using the interface element, order 354 in response to offer 318 and stores the order in memory 128. Element 314 generates redemption authorization 356 for offer 312 in response to order 354. That is, a prerequisite for validating, or enabling implementation or redemption of, offer 312 is receipt, in response to transmitting offer 318, of an order from an end user device (not shown) associated with address 316. In another embodiment, a time limit is placed upon the redemption of offer 318. For example, if offer 318 is not acted upon within a certain time frame, one or both of offers 312 and 318 are cancelled or modified.

In one embodiment, element 302 evaluates order 304 to determine if the order qualifies for the generation of offer 312. Any criteria known in the art can be used to evaluate, the order, for example, the cost of the order, profit associated with the order, or operational criteria, such as inventory on hand. In another embodiment, offer element 302 evaluates order 304 using at least one of at least one rule 358 or AI program 360, stored in memory 128. In a further embodiment, rule 358 is transmitted to computer 114 from a WCD, for example, WCD 118, 324, or 340; or from another computer, for example, computer 174 or 342. The discussion, in the description of FIG. 1, of WCD 118 and rules 172 and 178 and computer 174 and rules 176 and 180 is applicable to the WCD, for example, WCD 118, 324, or 340, and rule 358 and to the computer, for example, computer 174 or 342, and rule 358, respectively.

In one embodiment, element 302 determines if the EUD or an end user for the EUD is enrolled in a loyalty program, for example, any loyalty program known in the art. In another embodiment, offer 312 is transmitted only if the EUD or the end user for the EUD is enrolled in the loyalty program. In a further embodiment, offer 312 is transmitted only if the EUD or the end user for the EUD is not enrolled in the loyalty program. In yet another embodiment, membership in the loyalty program is otherwise considered in the generation of offer 312. For example, a larger discount may be presented in the offer to a non-member end user to attract the non-member user, or a larger discount may be presented in the offer to award a member end user.

In a first embodiment, element 302 transmits offer 312 to the same EUD from which order 304 was received. In a second embodiment, element 302 transmits offer 312 to a EUD different from the EUD from which order 304 was received. In a third embodiment, element 314 receives address 316 from the same EUD from which order 304 was received. In a fourth embodiment, element 314 receives address 316 from a EUD different from the EUD from which order 304 was received.

In one embodiment, system 300 interrupts a transaction involving the EUD, for example, the placing of order 304 by WCD 118, and transmits offer 312 to the EUD as part of the interruption. In another embodiment, system 300 provides a sub menu (not shown) that an end user of the EUD can select to see available offer 312, for example, during the placing of order 304 by WCD 118, an end user of WCD 118 can access the sub menu.

In one embodiment, system 300 determines if there are duplicate addresses among addresses 316 or if addresses in addresses 316 have already been acquired by system 300. In another embodiment, if duplicate addresses or already acquired addresses are found among addresses 316, the system prompts the end user to enter alternate email addresses. In a further embodiment, all or parts of offer 312 are withdrawn unless the alternative addresses are submitted.

In one embodiment, the nature or specifics of offer 312 or offer 318 are not provided when the offer is transmitted to the EUD. That is, the offers are “mystery” offers. In another embodiment, the recipient of offer 312 or offer 318 is required to log on to a website (not shown) associated with system 300 and enter a code provided with offer 312 or offer 318 to see what items or services can be redeemed for offer 312 or offer 318. In a further embodiment, offer 312 or offer 318 is only available for implementation with order 304 or order 354, respectively. In yet another embodiment, offer 312 or offer 318 is a coupon that can be fulfilled at a later date. The coupon can be printed coupon or an electronic coupon transmitted to the EUD.

In one embodiment, address 316 is a telephone numbers, a text message identification, or a social network identification. For example, address 316 is not limited to email addresses. In another embodiment, address 316 is rejected if the address is outside a specified area, for example, a specified radius of location 132. For example, address 316 is rejected if the address is an email address not located within a specified radius of the retail establishment, that is, only “local” emails are valid emails.

System 300 can be implemented using one or more a tables, rule, or genetic algorithm or any combination of a tables, rule, or genetic algorithm.

It should be understood that system 300 can be operated by the same business entity operating or owning a business location using the system, or can be operated by a third party different than the business entity operating or owning the business location using the system. In one embodiment, a third party operates system 300 as disclosed by commonly-owned U.S. patent application Ser. No. 11/985,141: “UPSELL SYSTEM EMBEDDED IN A SYSTEM AND CONTROLLED BY A THIRD PARTY,” inventors Otto et al., filed Nov. 13, 2007.

It should be understood that system 300 can be integral with a computer operating system for a business location, for example, location 132 or with a business entity operating the business location. It also should be understood that system 300 can be wholly or partly separate from the computer operating system for a retail location, for example, location 132, or with a business entity operating the retail location.

It should be understood that the examples above regarding executables or other operations by artificial intelligence programs are non-limiting, are meant to provide only a broad overview, and do not address the number, complexity, structure, or interrelationships of the operations included in the actual generation of the executables or functioning of the artificial intelligence programs.

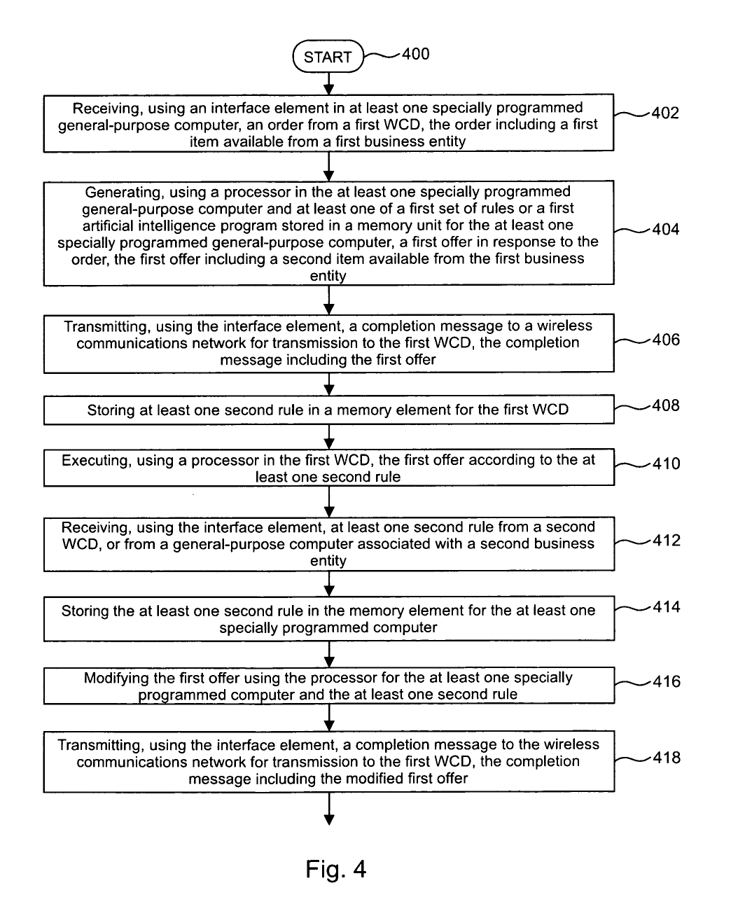

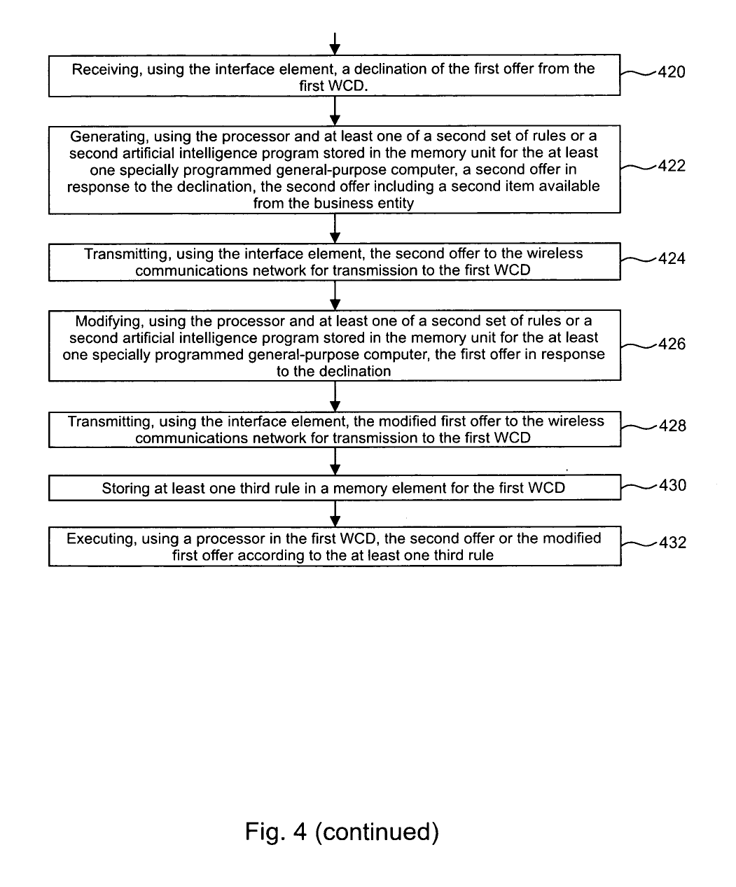

FIG. 4 is a flow chart illustrating a present invention computer-based method for generating an incentive for an end user to refer other end user. Although the method in FIG. 4 is depicted as a sequence of numbered steps for clarity, no order should be inferred from the numbering unless explicitly stated. The method starts at Step 400. Step 402 receives, using an interface element in at least one specially programmed general-purpose computer, a first order from an end user device, the first order for an item or service available from a first business entity; step 404 generates, using a processor in the at least one specially programmed general-purpose computer and at least one of a first set of rules or a first artificial intelligence program stored in a memory unit for the at least one specially programmed general-purpose computer, a first offer in response to the first order, redemption of the first offer contingent upon receipt, in the at least one specially programmed general-purpose computer, of an email address; step 406 transmits, using the interface element, the first offer; step 408 receives, using the interface element, at least one email address in response to the first offer; step 410 generates, using the processor, at least one second offer; and step 412 transmits, using the interface element, the at least one second offer to the at least one email address.

In a first embodiment, step 414 determines, using the processor, if the at least one email address is valid and transmitting the at least one second offer includes transmitting only to a valid at least one email address. In a second embodiment, generating the at least one second offer includes generating the at least one second offer using at least one of a second set of rules or a second artificial intelligence program stored in the memory unit. In a third embodiment, the first and second sets of rules are the same or the first and second artificial intelligence programs are the same.

In a fourth embodiment, the end user device is a wireless communications device (WCD), step 416 stores at least one second rule in a memory element for the WCD and step 418 executes, using a processor in the WCD, the first offer according to the at least one second rule.

In a fifth embodiment, step 420 receives, using the interface element, at least one second rule from a WCD, or from a general-purpose computer associated with a second business entity; step 422 stores the at least one second rule in the memory element; step 424 modifies the first offer using the processor and the at least one second rule; and step 426 transmits, using the interface element, the modified first offer to the end user device. In one embodiment, the end user device and the WCD are the same or the first and second business entities are the same.

In a sixth embodiment, step 428 receives, using the interface element, a second order in response to the second offer; and step 430 generates, using the processor, a redemption authorization for the first offer in response to receiving the second order. In one embodiment, transmitting the first offer includes transmitting the first offer to the end user device or receiving at least one email address includes receiving at the at least one email address from the end user device.

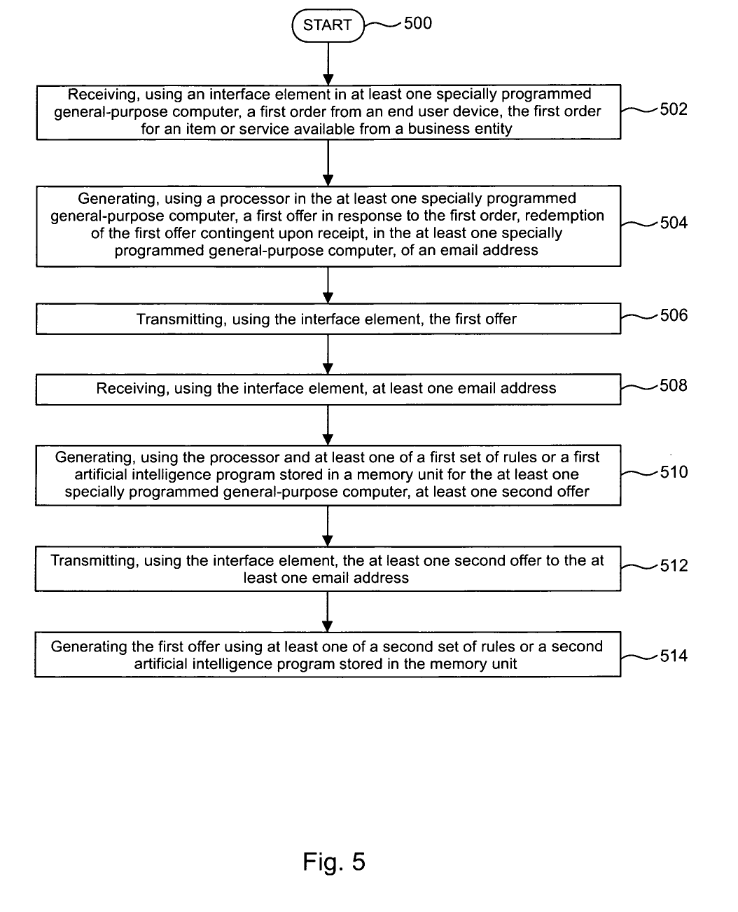

FIG. 5 is a flow chart illustrating a present invention computer-based method for generating an incentive for an end user to refer other end user. Although the method in FIG. 5 is depicted as a sequence of numbered steps for clarity, no order should be inferred from the numbering unless explicitly stated. The method starts at Step 500. Step 502 receives, using an interface element in at least one specially programmed general-purpose computer, a first order from an end user device, the first order for an item or service available from a business entity; step 504 generates, using a processor in the at least one specially programmed general-purpose computer, a first offer in response to the first order, redemption of the first offer contingent upon receipt, in the at least one specially programmed general-purpose computer, of an email address; step 506 transmits, using the interface element, the first offer; step 508 receives, using the interface element, at least one email address; step 510 generates, using the processor and at least one of a first set of rules or a first artificial intelligence program stored in a memory unit for the at least one specially programmed general-purpose computer, at least one second offer; and step 512 transmits, using the interface element, the at least one second offer to the at least one email address.

In one embodiment, step 514 generates the first offer using at least one of a second set of rules or a second artificial intelligence program stored in the memory unit.

The following is a non-limiting example of a possible sequence for a present invention method or system. A first general aspect is generating an offer, for example, offer 312. A possible sequence for this aspect includes: receive end user ID (optional); receive an order (for example, order 304); determine if order qualifies for referral offer; generate and output referral offer (for example, offer 312); receive referral email addresses (for example, addresses 316); validate email addresses; transmit referral offer (for example, offer 318) to email addresses; apply referral reward to referrer account and/or transaction.

A second general aspect is redeeming a reward or offer based on validated email addresses. A possible sequence for this aspect includes: receive sign up from email address; retrieve referrer of email address; determine if referrer has generated enough sign ups to receive a reward; supply reward to referrer account. A third general aspect asks for more addresses or adjusts incentive if supplied email addresses are not valid or redeemed. A possible sequence for this aspect includes: transmit referral offer email to email addresses; receive acceptance of referral offer from one or more addresses (for example, order 354); receive indication that offer timer period has lapsed; retrieve offer acceptances; determine if acceptances are adequate to receive reward; if acceptances are not adequate output request for additional addresses; and if necessary adjust reward.

The following should be viewed in light of FIGS. 1 through 5. The following is a non-limiting example of a present invention system or method. A fast serve restaurant is used to illustrate operation of a present invention system or method; however, it should be understood that a present invention system or method is not limited to use with a fast serve restaurant and that operation of a present invention system or method with any business entity providing an item or service to a customer is included within the spirit and scope of the claimed invention. The customer is an end user of WCD 118. Order 304 is placed by WCD 118 and restaurant 132 places the order in the appropriate queue. Offer element 302 generates and transmits offer 312 to the WCD. The offer presents an incentive to the end user of the WCD to provide one or more email addresses. The incentive could include, but is not limited to, a discount on order 304, a discounted or free item to add to order 304, or a printed or electronic coupon for later redemption. The discussion, in the description of FIG. 1, regarding the generation of offer 120 by offer element 108 is applicable to the generation of offer 312 by offer element 302. For example, rules, artificial intelligence, a history of an end user for WCD 118, and/or parameters associated with operation of the restaurant can be used to generate the offer.

Offer element 314 receives email addresses 316, generates offer 318, and transmits the offer to the email addresses. The redemption of offer 312 can be linked to parameters associated with addresses 316 or actions taken by end users at addresses 316. For example, system 300 can require that addresses 316 be new to the system or can require that an order, for example, order 354, be placed in response to offer 318. Order 304 can be paid for by any means known in the art, for example, billed to an electronic payment system associated with WCD 118, or can be paid using conventional methods in the restaurant. The end user is prompted to enter a payment type and the transaction is flagged as “paid with device” or “requires payment” at the POS unit (not shown) of the restaurant handling order 304. Tables, rules, or artificial intelligence can be used to generate one or both of offers 312 and 318. Rules for modifying offers 312 or 318 can be received from another computer or a WCD.

The following non-limiting example is directed to a WCD, for example, WCD 118, but it should be understood that an end user device in a present invention system is not limited to a WCD. Offer 312 can be implemented in any way known in the art, including, but not limited to: reinitiating a POS function on WCD 118, automatically logging in to a website on WCD 118, emailing WCD 118, text messaging WCD 118, or calling WCD 118.

In system 300, computer 114 is configured to generate and transmit an offer, for example offer 312 or offer 318, in response to an order using rules or AI programs. In one embodiment, a present invention system, for example, system 300, adds additional layers of distributed control and input or distributed control of the implementation of executables from the central system (computer 114). For example, computer 114 generates and optimizes an offer in response to an order. However, this operation is further constrained by rules provided an outside computer or WCD, for example, computer 342 or WCD 340. The rules, for example, rules 338 or 352, specified by a business entity associated with the outside computer, for example, computer 342, or specified by the WCD, for example, WCD 118, can be self generated or end user implemented. Rules or filters can all be stored at the central system, or can be distributed across the various pieces of hardware in system 300.

In another embodiment, computer 114 tracks search, purchase, and travel behavior of a WCD, such as WCD 118. In a further embodiment, retailers may import or otherwise access transaction history of WCD end users that are mapped to a specific WCD or group of WCDs.

Computer 114 can use data collected from a WCD as well as the data provided by one or more business entities about the WCD to generate offers to the WCD. System 300 also can serve as a point of sales system for the business entity associated with location 132, for example, enabling the entity to store transaction information about WCDs making purchases with the entity. Computer 114 can use the transaction history data to refine offers made to WCDs. In still another embodiment, computer 114 operates as a phone service provider and web search engine for the WCDs, enabling the computer to store a call log of the WCDs which can be used to refine offers made to WCDs.

The present invention can use tables, rules, genetic algorithms or any combination of the forgoing.

In one embodiment, if offer 312 or 318 is rejected, or otherwise not acted upon, an additional offer can be made and transmitted or the original offer can be modified and re-transmitted as disclosed by commonly-owned U.S. patent application Ser. No. 12/151,038, filed May 2, 2008 and entitled “Method and Apparatus for Generating and Transmitting an Order Initiation Offer to a Wireless Communications Device.”

The following provides additional information regarding a present invention method or system. In a first embodiment, existing loyalty members are sent marketing messages and other communications, which may be accomplished via any applicable means, including, for example, email messages, text messages and other communications. In one embodiment, the messages are sent responsive to receipt of an order, such as described for offer 312. Such messages may include one or more marketing offers and content. For example, in an effort to expand an existing loyalty club's membership roster, the present invention might offer existing loyalty members a coupon for a free or discounted item or items, if: a) the existing loyalty member will provide one or more referral, i.e., prospective/note currently signed up prospective loyalty club members' email address and/or other personal or contact information, b) such referral/prospective members' information may be partially of fully verified, and/or c) such referrals/prospective member takes or completes some other optional or required action(s), including, but not limited to: sign up for the loyalty program, verify or provide personal information, opt into one or more marketing programs, print and/or redeem a coupon or otherwise consummate the relationship/identification step by visiting the store, or otherwise making a purchase, e.g., at a kiosk or online or otherwise.

Marketing offers to existing members can be of any conceivable type, including, but not limited to:
1. Provide new/ prospective member(s) information and receive a reward (see example rewards listing below).
2. When/if such prospective member(s) information is partially or fully verified and receive a reward.
3. When/if such prospective member(s) sign up for the loyalty program and/or make at least one initial purchase and receive a reward.
4. Each successive purchase made by a referral may provide some further benefit to the loyalty member that referred such new members, e.g., points or other benefits, e.g., discounts or rewards, may accrue for each successive purchase. Such accrual may be on a short or long term or permanent basis. Such points or other reward types may remain constant or may vary over time and/or based upon the transaction type or contents or value, i.e., total dollars spent, store location, membership type (of either the new member or the member that referred such member), number and/or type of additional referrals provided by the new member, e.g., a first loyalty member recommends a second loyalty member, who, in turn recommends yet another, third loyalty member and so on.
5. In certain embodiments, only the first level of referrals receive rewards, i.e., the first loyalty member only receives benefits related to such direct referrals, e.g., the second loyalty member and the second loyalty member only receives benefits from activities, e.g., purchases, made by direct referrals, e.g., said third loyalty member. In another embodiment, loyalty members may receive the same or some different reward(s) from any or all secondary, tertiary or greater sub-referrals, e.g., said first loyalty member might receive rewards for any/all direct referrals, e.g., said second loyalty member, and/or additional members, e.g., said third loyalty member. In this fashion a loyalty member may receive benefit from each direct referral and, optionally, some or all additional sub-referrals. This encourages the loyalty member to continue to provide both direct and indirect referrals.
6. Loyalty members might receive a coupon or other marketing offer in exchange for prospective members, e.g., referrals. Such coupon may only become valid if/when such referral either signs up and/or redeems a similar or other coupon offer. For example, a first loyalty member receives an offer of a free hamburger for each referral provided that is either/or, a) verified as a unique, new member, b) signs up for the membership/loyalty program, c) prints or otherwise receives a marketing offer, and/or d) actually completes a purchase based upon such marketing offer, and/or e) verifies such contact and/or other membership information as requested/required/desired by said loyalty program sign up application(s), and/or f) any combination of the foregoing, or such other tasks as may be desired by any such loyalty program.
7. Referrals may receive a marketing offer to join the loyalty program and verify their information, e.g., identity or email or cell phone number. For example, a referral might receive an offer of a free hamburger if such referral will sign up to the loyalty program and, optionally, visit a retail location and redeem such coupon or marketing offer. Such offer may also require or otherwise encourage such new member to provide a referral as well. In any event, such referral may then be required to make a purchase at a retail location and/or online or via any other applicable means in order to either verify their identity, provide additional information, and/or consummate a purchase.
8. Rewards may be provided to loyalty members based upon their own purchases, store visit frequency, willingness to try new or suggested products, willingness to use kiosks or other ordering devices, e.g., online, and/or favorable changes in any of the foregoing or a favorable trend, and/or based upon the number or type of referrals provided, whether or not such referral is verified and/or makes purchases, and/or any of the foregoing relating to such referral, e.g., such referrals purchases, and/or referrals of referrals and so on, and/or any combination of any of the foregoing, or any other applicable performance determination or calculation or programs as determined by the system and/or as desired by the retail outlet or chain.

Marketing offers may be delivered and/or redeemed using any applicable means, including, but not limited to: delivery via email, voice mail, text messages, regular or express mail or via a popup display online, at a kiosk, PDA, cell phone or on a customer display at a POS terminal, drive through or any other location. Redemptions of coupons may be made at any applicable location, including, but not limited to, at a kiosk, POS terminal, customer facing display at a POS station, cell phone, PDA, or online. Such redemption may include a verification or validation step associated with such coupon or marketing offer, including, but not limited to one or more of the following identification or verification means: a bar code or other key code, which, when scanned or otherwise entered may provide information about such coupon, the customer, marketing offer, or other terms and conditions. For example, when the customer or cashier scans the coupon it may verify or identify and/or require the person redeeming such a coupon to identify them, and/or may verify that the coupon is still valid, e.g., a date has not passed, and/or the coupon has not yet been redeemed and/or it fulfills other redemption criteria.

In a second embodiment, a coupon is sent to one, a group, class or all email or other provided addresses stored in a database created for such purposes. In one embodiment, a coupon may be sent to a person in order to entice such person to sign up for a loyalty or frequency program and/or to encourage such person to encourage others to sign up to such a loyalty or frequency program.

In a third embodiment, one or more existing members may receive one or more offers to provide one or more email addresses of one or more prospective members in exchange for one or more marketing offers. For example, upon completion of a transaction at a kiosk or online or after signing up for a loyalty or frequency program, an existing member may receive an offer to receive a coupon or marketing offer, such as a free or discounted hamburger if such existing member provides at least one email address and/or other information of prospective member(s) that could be used to invite such prospective member(s) to join the same or other loyalty or frequent shopper program.

Such coupon or marketing offer may be enabled or able to be used or redeemed by any applicable means and based upon any one or more marketing program or other terms and conditions, including immediate use or upon verification of such one or more email addresses, upon successful transmission of one or more marketing messages or offers to such one or more email address, upon such prospective member's response to such coupon or marketing offer, which response includes, but is not limited to, for example, signing up to the loyalty, frequency or other marketing program, acceptance and/or use, e.g., redemption, of the offer or coupon, opting in to one or more loyalty, frequency or other marketing program(s), achieving or maintaining a certain level of sales and/or number or frequency of store visits, purchases of certain products, providing one or more additional email addresses, visiting one or more retail, restaurant or other store location(s), filling out or providing additional information, such as mailing address, phone number, internet device id information, and/or signing up for one or more third party sponsor programs, and/or any other action as determined or established by the marketing program or any combination of the foregoing.

In a fourth embodiment, a prospective member may receive an offer that is the same or similar and/or dissimilar to the offer received by the existing member to sign up and/or take any other desired actions, such as any of the above mentioned responses or any other action or response by the prospective or existing member.

In a fifth embodiment, one or more end users may provide one or more email address or other useful information of or relating to one or more prospective members in exchange for one or more marketing offers or other benefits. Such offers may be determined, delivered and/or presented using any applicable means, including, for example, at any time while the existing member is in communication with the marketing program and/or retailer, restaurant owner and/or POS device. For example, post ordering, an existing member may be given an offer for a free milkshake if they provides at least five valid email addresses of prospective members and that at least one of such prospective members signs up for the marketing program and redeems at least one coupon or other marketing offers and/or opts into the marketing program or otherwise responds.

By providing existing members with incentives, which may not be limited in number, to encourage other prospective members to sign up, respond or otherwise opt in to one or more marketing programs, such marketing programs are more likely to expand their membership, and, by continuing such process, e.g., continuing to send offers to both existing and new members, such growth can become exponential.

In a fifth embodiment, once the marketing program has members, the system can begin to make one or more offers. Such offers and the results of those offers, e.g., responses, sales, profits, customer frequency, average check, customer survey responses, and other information can be tracked. Subsequent offers can then be modified based upon such results. Such subsequent offers may be modified or adapted using any applicable means, for example, as described for offer element 108 in FIG. 1.

In a sixth embodiment, a prospective member must either visit a store location and/or redeem or otherwise accept a marketing offer in order to become a member and/or to be permitted to recommend any additional new members and/or receive any additional or future marketing offers.

In a seventh embodiment, if one or more email addresses or other customer or other information supplied by an existing member proves inaccurate, such existing member may be penalized including, for example, being precluded from submitting additional information, redeeming or otherwise benefiting from one or more marketing offers, which may or may not have been provided in exchange for such prospective customer's information, and/or a reduction in the amount or/of benefit, e.g., instead of a free hamburger, the existing member might only receive a half price French fry.

In an eighth embodiment, marketing offers and/or penalties and other terms and conditions may be established via any applicable means, including, for example, via use of rules that are established by the store location manager and/or any other duly authorized end user and/or via one or more learning algorithms including use of a neural net or genetic or other learning algorithms. Such offers may be based in whole or in part upon any or all available customer or other information.

In a ninth embodiment, existing members or any person can receive a coupon and forward the coupon to a prospective member or any other person. Delivery of such coupon may be accomplished via any applicable means, including, for example, via an email marketing campaign, which includes email messages sent to existing or prospective or any other person and which message includes one or more coupons or other marketing offers, and/or via delivery of printed coupons or marketing offers, e.g., via a newspaper, or hand outs in an existing location, etc. Use of such coupon or marketing offer may be tied to such recipient signing up for or opting into the marketing program and/or encouraging others to do likewise.

In an eleventh embodiment, end users may identify themselves using overt actions, e.g., by swiping a card, in other embodiments, in addition or in the alternative to providing such identification means overtly, such end users may identify themselves passively. In one embodiment, the system uses such identification means to retrieve information about an end user, e.g., customer, business or sponsor information, which information may be further used to better or optimally determine if an offer or marketing message should be sent or otherwise provided to said end user.

The following is a listing of exemplary hardware and software that can be used in a present invention method or system. It should be understood that a present invention method or system is not limited to any or all of the hardware or software shown and that other hardware and software are included in the spirit and scope of the claimed invention.
End user device: self order entry kiosk; POS terminal; card authorization terminal; cell phone; PDA; in-car GPS; and any WCD known in the art.
Store Server (for example for location 132 and computer 114): Referral Offer Program and Referral Redemption Program

The following is a listing of exemplary data bases that can be used in a present invention method or system. It should be understood that a present invention method or system is not limited to any or all of the databases shown and that other databases are included in the spirit and scope of the claimed invention.
Customer Database: Customer ID; Customer Transaction History; Personal Information; Email Address; Offers made 1-n; Referrer ID; Referral ID; and Status.
Inventory Database: Item ID; Descriptor; QTY; and Price.
Transaction Database: Transaction ID; Items 1-n; Offer ID 1-n; Offer Accepted; Accepted Offer Type; Referral Offer ID; Referral Offer Accepted; Email addresses received; Email addresses validated; and Email addresses activated.
Reward Database: Reward ID; Item ID 1-n; Reward Rules 1-n; and Customer ID 1-n.
Referral Offer Database: Referral Offer ID; Customer ID 1-n; Offer Information; and Offer Rules and Conditions.

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

What is claimed is:

1. A method for generating an incentive for an end user to refer other end users, comprising the steps of:
receiving, using an interface element in at least one specially programmed general-purpose computer, a first order from a first end user device, the first order for an item or service available from a first business entity;
generating, using a processor in the at least one specially programmed general-purpose computer and at least one of a first set of rules or a first artificial intelligence program stored in a memory unit for the at least one specially programmed general-purpose computer, a first offer in response to the first order, redemption of the first offer related to receipt, in the at least one specially programmed general-purpose computer, of an email address;
transmitting, using the interface element, the first offer;
receiving, using the interface element, at least one email address from the first end user device;
generating, using the processor, at least one second offer; and,
transmitting, using the interface element, the at least one second offer to the at least one email address.

2. The method of claim 1 further comprising the step of determining, using the processor, if the at least one email address is valid and wherein transmitting the at least one second offer includes transmitting only to a valid at least one email address.

3. The method of claim 1 wherein generating the at least one second offer includes generating the at least one second offer using at least one of a second set of rules or a second artificial intelligence program stored in the memory unit.

4. The method of claim 3 wherein the first and second sets of rules are the same or the first and second artificial intelligence programs are the same.

5. The method of claim 1 wherein the first end user device is a wireless communications device (WCD) and the method further comprising the steps of:
storing at least one second rule in a memory element for the WCD; and,
executing, using a processor in the WCD, the first offer according to the at least one second rule.

6. The method of claim 1 further comprising the steps of:
receiving, using the interface element, at least one second rule from a WCD, or from a general-purpose computer associated with a second business entity;
storing the at least one second rule in the memory element;
modifying the first offer using the processor and the at least one second rule; and,
transmitting, using the interface element, the modified first offer to the end user device.

7. The method of claim 6 wherein the first end user device and the WCD are the same or wherein the first and second business entities are the same.

8. The method of claim 1 further comprising the steps of:
receiving, using the interface element, a second order, in response to the second offer, from a second end user device; and,
generating, using the processor, a redemption authorization for the first offer in response to receiving the second order.

9. The method of claim 1 wherein transmitting the first offer includes transmitting the first offer to the first end user device or wherein receiving at least one email address includes receiving at the at least one email address from the first end user device.

10. The method of claim 1 wherein transmitting the second offer includes transmitting a coupon for the second offer and the method further comprising the steps of:
receiving, using the interface element and the processor, information regarding the coupon;
validating, using the processor, the coupon; and,
initiating, using the interface element and the processor, a second order including the second offer.

11. A system for generating an incentive for an end user to refer other end users, comprising:
a first offer element, in a processor for at least one specially programmed general-purpose computer, arranged to:
receive, using an interface element for the at least one specially programmed general-purpose computer, a first order from a first end user device, the first order for an item or service available from a first business entity;
generate, using the processor and at least one of a first set of rules or a first artificial intelligence program stored in a memory unit for the at least one specially programmed general-purpose computer, a first offer in response to the first order, redemption of the first offer related to receipt, in the at least one specially programmed general-purpose computer, of an email address; and,
transmit, using the interface element, the first offer; and,
a second offer element, in the processor, arranged to:
receive, using the interface element, at least one email address from the first end user device;
generate, using the processor, at least one second offer; and,
transmit, using the interface element, the at least one second offer to the at least one email address.

12. The system of claim 10 wherein the second offer element is arranged to determine if the at least one email address is valid and to transmit the at least one second offer only to a valid at least one email address.

13. The system of claim 10 wherein the second offer element is arranged to generate the at least one second offer using at least one of a second set of rules or a second artificial intelligence program stored in the memory unit.

14. The system of claim 12 wherein the first and second sets of rules are the same or the first and second artificial intelligence programs are the same.

15. The system of claim 10 wherein the first end user device is a wireless communications device (WCD) with a memory element and a processor and the WCD is arranged to store at least one second rule in the memory element for the WCD and to execute, using the processor in the WCD, the first offer according to the at least one second rule.

16. The system of claim 10 wherein the first offer element is arranged to:
receive, using the interface element, at least one second rule from a WCD, or from a general-purpose computer associated with a second business entity;
store the at least one second rule in the memory element;
modify the first offer using the at least one second rule; and,
transmit, using the interface element, the modified first offer to the first end user device.

17. The system of claim 15 wherein the first end user device and the WCD are the same or wherein the first and second business entities are the same.

18. The system of claim 10 wherein the second offer element is arranged to receive, using the interface element, a second order, in response to the second offer, from a second end user device and to generate a redemption authorization for the first offer in response to receiving the second order.

19. The system of claim 10 wherein the first offer element is arranged to transmit the first offer to the first end user device or wherein the second offer element is arranged to receive the at least one email address from the first end user device.

20. A method for generating an incentive for an end user to refer other end users, comprising the steps of:
receiving, using an interface element in at least one specially programmed general-purpose computer, a first order from an end user device, the first order for an item or service available from a business entity;
generating, using a processor in the at least one specially programmed general-purpose computer, a first offer in response to the first order, redemption of the first offer contingent upon receipt, in the at least one specially programmed general-purpose computer, of an email address;
transmitting, using the interface element, the first offer to the end user device;
receiving, using the interface element, at least one email address from the end user device;
generating, using the processor and at least one of a first set of rules or a first artificial intelligence program stored in a memory unit for the at least one specially programmed general-purpose computer, at least one second offer; and,
transmitting, using the interface element, the at least one second offer to the at least one email address.

21. The method of claim 19 wherein generating a first offer includes generating the first offer using at least one of a second set of rules or a second artificial intelligence program stored in the memory unit.

22. A system for generating an incentive for an end user to refer other end users, comprising:
a first offer element, in a processor for at least one specially programmed general-purpose computer, arranged to:
receive, using an interface element for the at least one specially programmed general-purpose computer, a first order from an end user device, the first order for an item or service available from a first business entity;
generate, using the processor, a first offer in response to the first order, redemption of the first offer contingent upon receipt, in the at least one specially programmed general-purpose computer, of an email address; and,
transmit, using the interface element, the first offer to the end user device; and,
a second offer element, in the processor, arranged to:
receive, using the interface element, at least one email address, in response to the first offer, from the end user device;
generate, using the processor and at least one of a first set of rules or a first artificial intelligence program stored in a memory unit for the at least one specially programmed general-purpose computer, at least one second offer; and,
transmit, using the interface element, the at least one second offer to the at least one email address.

23. The system of claim 22 wherein the first offer element is arranged to generate the at least one first offer using at least one of a second set of rules or a second artificial intelligence program stored in the memory unit.
